(19) United States
(12) Patent Application Publication
(10) Pub. No.: US 2011/0197625 A1
(43) Pub. Date: Aug. 18, 2011

(54) Ergonomic Coolers

(75) Inventors: Hayes M. Urban, Austin, TX (US); Matthew C. Grossman, Austin, TX (US); Kit R. Morris, Austin, TX (US); John Maldonado, Katy, TX (US); James B. Duke, Katy, TX (US)

(73) Assignee: Igloo Products Corp.

(21) Appl. No.: 13/025,634

(22) Filed: Feb. 11, 2011

Related U.S. Application Data
(60) Provisional application No. 61/303,913, filed on Feb. 12, 2010.

(51) Int. Cl. F25D 3/08; B23P 19/04

(52) U.S. Cl. 62/457.1; 29/428

(57) ABSTRACT

A cooler includes a body, a cover coupled to the body, and an extendable handle. The body includes a base, a first and second sidewall extending from the base and positioned to face one another, and a third and fourth sidewall extending from the base and positioned to face one another. The third and fourth sidewalls extend from the first sidewall to the second sidewall. The handle includes a first and second bar and a center bar extending from one end of the first bar to one end of the second bar. The handle is positionable in an extended position and a retracted position. In the retracted position, the horizontal component of the distance from the center bar to the fourth sidewall is less than when the positioned in the extended position. The handle is either slidably coupled or telescopically coupled to the first and second sidewalls.

### CROSS-REFERENCE TO RELATED APPLICATIONS

This application claims priority to U.S. Provisional Patent Application No. 61/303,913, titled “Ergonomic Coolers,” filed Feb. 12, 2010, the entirety of which is incorporated by reference herein.

### FIELD OF THE DISCLOSURE

The present disclosure relates generally to insulated coolers. More specifically, the disclosure relates to a wheeled insulated cooler having at least one handle for transporting the cooler.

### BACKGROUND

Conventional coolers are typically fabricated using a plastic material and have some form of insulation disposed between an outer wall and an inner wall. The inner wall is shaped to form a cavity therein. Typically, refreshments, picnic foods, and/or plenty of ice are placed within the cavity to be stored and maintained at cooler temperatures longer than if stored in the outside environment. Conventional coolers typically provide a pair of handles, each handle coupled to opposing sides of the cooler on the outer walls. These handles assist a user in lifting and transporting the cooler. However, the cooler can become quite heavy once filled with these items, especially if allowed to reach full capacity or near full capacity. Thus, lifting and transporting the cooler becomes difficult and causes strain to the user.

### SUMMARY

One exemplary embodiment includes a cooler. The cooler can include a body, a cover, and a handle. The body can define a cavity therein and can include a base, a first and second sidewall, and a third and fourth sidewall. Each of the first and second sidewalls can extend from the base and can be positioned to face one another. Each of the third and fourth sidewalls can extend from the base. The third sidewall can extend from the first sidewall to the second sidewall. The fourth sidewall can extend from the first sidewall to the second sidewall. The third sidewall can be facing the fourth sidewall. The cover can be coupled to the body and can enclose the cavity when in a closed position. The handle can include a first bar, a second bar, and a center bar that can extend from one end of the first bar to one end of the second bar. The first bar can be coupled to the first sidewall. The second bar can be coupled to the second sidewall. The handle can be extendable from a retracted position to an extended position. The horizontal component of the distance between the center bar and the fourth sidewall can be lesser when the handle is positioned in the retracted position than when the handle is positioned in the extended position.

Another exemplary embodiment includes a method for assembling an insulated cooler. The method can include providing defining a cavity therein. The body can include a base, a first and second sidewall, and a third and fourth sidewall. Each of the first and second sidewalls can extend from the base and can be positioned to face one another. Each of the third and fourth sidewalls can extend from the base. The third sidewall can extend from the first sidewall to the second sidewall. The fourth sidewall can extend from the first sidewall to the second sidewall. The third sidewall can be facing the fourth sidewall. The method also can include coupling a handle to the first and second sidewalls. The handle can include a first bar, a second bar, and a center bar that can extend from one end of the first bar to one end of the second bar. The first bar can be coupled to the first sidewall. The second bar can be coupled to the second sidewall. The handle can be extendable from a retracted position to an extended position. The method can further include coupling at least one wheel assembly to the base. The horizontal component of the distance between the center bar and the fourth sidewall can be lesser when the handle is positioned in the retracted position than when the handle is positioned in the extended position.

Another exemplary embodiment includes a cooler. The cooler can include a body, a handle, and at least one wheel assembly. The body can include a base, a first and second sidewall, and a third and fourth sidewall. Each of the first and second sidewalls can extend from the base and can be positioned to face one another. Each of the third and fourth sidewalls can extend from the base. The third sidewall can extend from the first sidewall to the second sidewall. The fourth sidewall can extend from the first sidewall to the second sidewall. The third sidewall can be facing the fourth sidewall. The handle can include a first bar, a second bar, and a center bar that can extend from one end of the first bar to one end of the second bar. The first bar can be coupled to the first sidewall. The second bar can be coupled to the second sidewall. The handle can be extendable from a retracted position to an extended position. At least one wheel assembly can be coupled to the lower portion of the base adjacent the third sidewall. The length of the handle between the center bar and the fourth sidewall can be greater than the vertical height of the fourth sidewall when the handle is positioned in the extended position.

### BRIEF DESCRIPTION OF THE DRAWINGS

For a more complete understanding of the present invention and the advantages thereof, reference is now made to the following description, in conjunction with the accompanying figures briefly described as follows:

FIG. 1A is a side view of an insulated cooler according to an exemplary embodiment of the present invention;

FIG. 1B is a perspective view of the insulated cooler of FIG. 1A according to the exemplary embodiment of the present invention;

FIG. 2 is a side view of the insulated cooler of FIG. 1A with the handle being removed according to the exemplary embodiment of the present invention;

FIG. 3A is a perspective view of the handle of the insulated cooler of FIG. 1A according to the exemplary embodiment of the present invention;

FIG. 3B is an exploded view of the handle of FIG. 3A according to the exemplary embodiment of the present invention;

FIG. 4 is a side view of the insulated cooler of FIG. 1A with the handle being in an extended and tilted position according to the exemplary embodiment of the present invention;

FIG. 5 is a side view of an insulated cooler according to a second exemplary embodiment of the present invention;

FIG. 6A is a side view of an insulated cooler according to a third exemplary embodiment of the present invention;

FIG. 6B is a perspective view of the insulated cooler of FIG. 6A according to the third exemplary embodiment of the present invention;

FIG. 7 is a side view of the insulated cooler of FIG. 6A with the handle being removed according to the third exemplary embodiment of the present invention;

FIG. 8A is a side view of the handle of the insulated cooler of FIG. 6A in a retracted position according to the third exemplary embodiment of the present invention;

FIG. 8B is an exploded view of the handle of FIG. 8A according to the third exemplary embodiment of the present invention;

FIG. 8C is a side view of the handle of the insulated cooler of FIG. 6A in an extended position according to the third exemplary embodiment of the present invention; and

FIG. 9 is a side view of the insulated cooler of FIG. 6A with the handle being in an extended position according to the third exemplary embodiment of the present invention.

The drawings illustrate only exemplary embodiments of the invention and are therefore not to be considered limiting of its scope, as the invention may admit to other equally effective embodiments.

### DETAILED DESCRIPTION OF THE EXEMPLARY EMBODIMENTS

Embodiments of the present invention are directed to insulated coolers. In particular, the application is directed to a wheeled insulated cooler having at least one handle for transporting the cooler. The invention may be better understood by reading the following description of non-limiting, exemplary embodiments with reference to the attached drawings, wherein like parts of each of the figures are identified by like reference characters, and which are briefly described as follows.

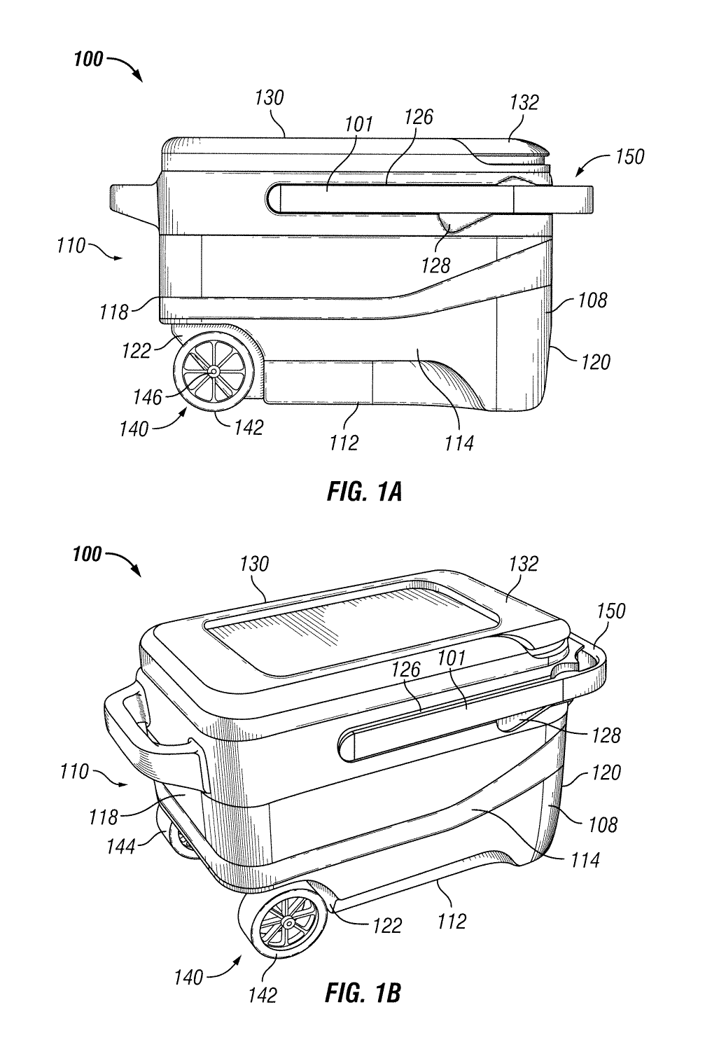

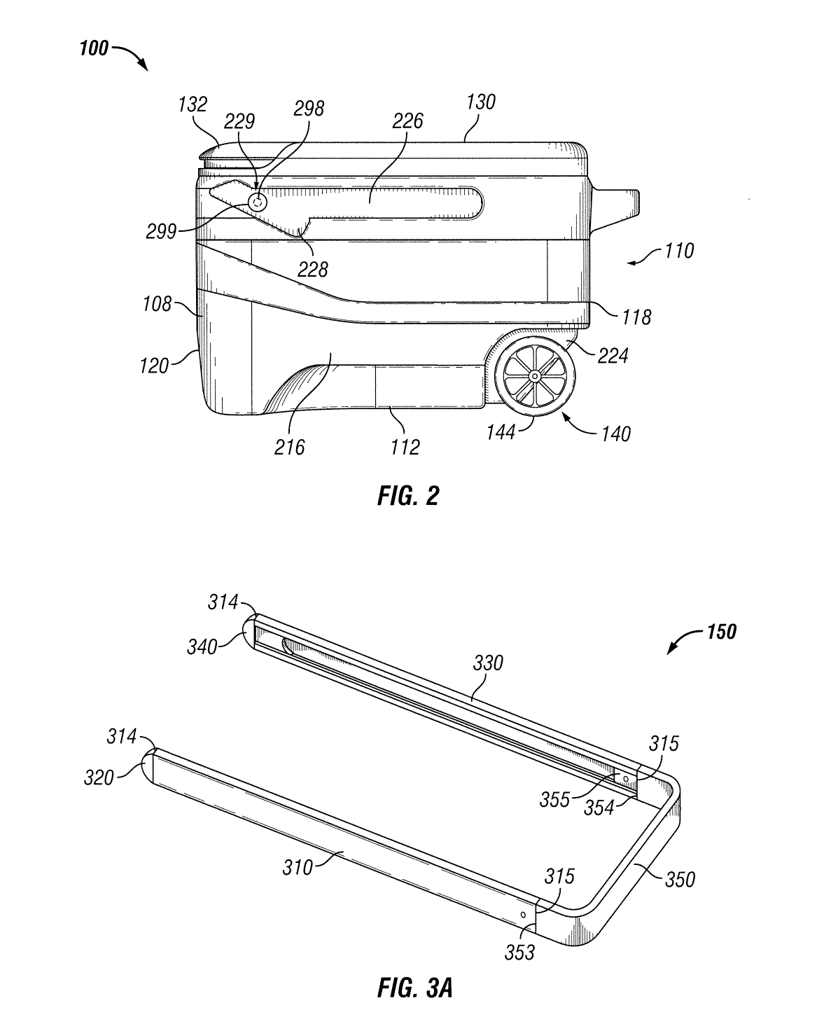

FIGS. 1A and 1B are various views of an insulated cooler 100 according to an exemplary embodiment of the present invention. FIG. 2 is a side view of the insulated cooler 100 with a handle 150 being removed according to the exemplary embodiment of the present invention Referring to FIGS. 1A, 1B and 2, the insulated cooler 100 includes a body 110, an upper cover 130, a wheel assembly 140, and a handle 150. The insulated cooler 100 generally is rectangularly shaped; however, the insulated cooler 100 is shaped in other geometric or non-geometric shapes in alternative exemplary embodiments.

The body 110 includes a base 112, a first longitudinal sidewall 114, a second longitudinal sidewall 216, a first latitudinal sidewall 118, and a second latitudinal sidewall 120. The first longitudinal sidewall 114 and the second longitudinal sidewall 216 both extend upwardly from the base 112 at opposing edges of the base 112 such that the first longitudinal sidewall 114 and the second longitudinal sidewall 216 are substantially parallel to one another. However, in other exemplary embodiments, the first longitudinal sidewall 114 and the second longitudinal sidewall 216 are not substantially parallel to one another. Similarly, the first latitudinal sidewall 118 and the second latitudinal sidewall 120 both extend upwardly from the base 112 at opposing edges of the base 112 such that the first latitudinal sidewall 118 and the second latitudinal sidewall 120 are substantially parallel to one another and substantially perpendicular to each of the first longitudinal sidewall 114 and the second longitudinal sidewall 216. However, in other exemplary embodiments, the first latitudinal sidewall 118 and the second latitudinal sidewall 120 are not substantially parallel to one another and are not substantially perpendicular to each of the first longitudinal sidewall 114 and the second longitudinal sidewall 216. The base 112, the first longitudinal sidewall 114, the second longitudinal sidewall 216, the first latitudinal sidewall 118, and the second latitudinal sidewall 120 are coupled to one another to define a cavity (not shown) formed therein. In certain exemplary embodiments, the first and second longitudinal sidewalls 114, 216 become the first and second latitudinal sidewalls 118, 120, respectively, and the first and second latitudinal sidewalls 118, 120 become the first and second longitudinal sidewalls 114, 216, respectively.

Each of the base 112, the first longitudinal sidewall 114, the second longitudinal sidewall 216, the first latitudinal sidewall 118, and the second latitudinal sidewall 120 includes an outer wall 108 exposed to the outside environment and an inner wall (not shown) which surrounds the cavity. An insulation (not shown), such as Styrofoam®, is disposed between the outer wall 108 and the inner wall to facilitate in keeping the contents placed within the cavity cooler for a longer time period than if insulation were not provided. The outer wall 108 of each of the base 112, the first longitudinal sidewall 114, the second longitudinal sidewall 216, the first latitudinal sidewall 118, and the second latitudinal sidewall 120 are coupled together. In one exemplary embodiment, the outer wall 108 of each of base 112, the first longitudinal sidewall 114, the second longitudinal sidewall 216, the first latitudinal sidewall 118, and the second latitudinal sidewall 120 are molded together as a uniform component. Similarly, the inner wall of each of the base 112, the first longitudinal sidewall 114, the second longitudinal sidewall 216, the first latitudinal sidewall 118, and the second latitudinal sidewall 120 are coupled together. In one exemplary embodiment, the inner wall of each of base 112, the first longitudinal sidewall 114, the second longitudinal sidewall 216, the first latitudinal sidewall 118, and the second latitudinal sidewall 120 are molded together as a uniform component. According to one exemplary embodiment, the outer wall 108 is fabricated using a polymer material; however, other suitable materials known to persons having ordinary skill in the art can be used without departing from the scope and spirit of the exemplary embodiment. Similarly, according to one exemplary embodiment, the inner wall also is fabricated using a polymer material; however, other suitable materials known to persons having ordinary skill in the art can be used without departing from the scope and spirit of the exemplary embodiment.

According to certain exemplary embodiments, the base 112, the first longitudinal sidewall 114, and the first latitudinal sidewall 118 are shaped and coupled to one another to form a first recess 122 substantially where each of the base 112, the first longitudinal sidewall 114, and the first latitudinal sidewall 118 couple to one another. The first recess 122 is formed at an exterior portion of the body 110. Although the first recess 122 is formed in some exemplary embodiments, the first recess 122 is formed at a different location of approximately where at least the base 112 and the first longitudinal sidewall 114 are coupled to one another or is not formed altogether according to certain exemplary embodiments. For example, the first recess 122 is formed substantially half-way the longitudinal length of the first longitudinal sidewall 114 in certain exemplary embodiments. A second recess 224, similar to the first recess 122, is formed at another portion of the base 110. In one example, the second recess 224 is formed substantially where each of the base 112, the second longitudinal sidewall 216, and the first latitudinal sidewall 118 couple to one another. The second recess 224 also is formed at an exterior portion of the body 110. Although the second recess 224 is formed in some exemplary embodiments, the second recess 224 is formed at a different location of approximately where at least the base 112 and the second longitudinal sidewall 216 are coupled to one another or is not formed altogether according to certain exemplary embodiments. For example, the second recess 224 is formed substantially half-way the longitudinal length of the second longitudinal sidewall 216 in certain exemplary embodiments.

The first longitudinal sidewall 114 also includes a first slot 126. The first slot 126 is substantially horizontally oriented, which is at about zero degrees to the horizontal, and is recessed a desired depth into the first longitudinal sidewall 114. In certain exemplary embodiments, however, the first slot 126 is not horizontally oriented. The first slot 126 is positioned in the upper portion of the first longitudinal sidewall 114 according to some exemplary embodiments. In certain exemplary embodiments, the first slot 126 is positioned near the top edge of the first longitudinal sidewall 114. However, in certain exemplary embodiments, the first slot 126 is not positioned in the upper portion of the first longitudinal sidewall 114. The first slot 126 extends a portion of the length of the first longitudinal sidewall 114; however, the first slot 126 extends substantially the entire length of the first longitudinal sidewall 114 in other exemplary embodiments, which is from about the edge of the first longitudinal sidewall 114 that is coupled to the first latitudinal sidewall 118 to about the edge of the first longitudinal sidewall 114 that is coupled to the second latitudinal sidewall 120. According to several exemplary embodiments, one end of the first slot 126 extends to about the edge of the first longitudinal sidewall 114 which is coupled to the second latitudinal sidewall 120.

In certain exemplary embodiments, the first longitudinal sidewall 114 also includes an optional second slot 128. The second slot 128 is substantially angularly oriented with respect to the first slot 126. In one example, the second slot 128 is oriented at an angle of about thirty degrees with respect to the first slot 126; however, this angle ranges from about five degrees to about 175 degrees depending upon the orientation of the first slot 126. The second slot 128 also is recessed a desired depth into the first longitudinal sidewall 114, which is about the same depth that the first slot 126 is recessed according to certain exemplary embodiments. The second slot 128 is positioned to intersect approximately the end or the end of the first slot 126 that is positioned closer to the second latitudinal sidewall 120. According to some exemplary embodiments, a portion of the second slot 128 extends above the first slot 126, while a portion of the second slot 128 also extends below the first slot 126. The second slot 128 is formed to smoothly transition into the first slot 126.

A first protrusion (not shown) extends outwardly from the first longitudinal sidewall 114 at the intersection of the first slot 126 and the second slot 128. The first protrusion is formed similarly to a second protrusion 229 formed on the second longitudinal sidewall 216, which is discussed in further detail below.

The second longitudinal sidewall 216 also includes a first slot 226. The first slot 226 is substantially horizontally oriented, which is at about zero degrees to the horizontal, and is recessed a desired depth into the second longitudinal sidewall 216. In certain exemplary embodiments, however, the first slot 226 is not horizontally oriented. The first slot 226 is positioned in the upper portion of the second longitudinal sidewall 216 according to some exemplary embodiments. In certain exemplary embodiments, the first slot 226 is positioned near the top edge of the second longitudinal sidewall 216. However, in certain exemplary embodiments, the first slot 226 is not positioned in the upper portion of the second longitudinal sidewall 216. The first slot 226 extends a portion of the length of the second longitudinal sidewall 216; however, the first slot 226 extends substantially the entire length of the second longitudinal sidewall 216 in other exemplary embodiments, which is from about the edge of the second longitudinal sidewall 216 that is coupled to the first latitudinal sidewall 118 to about the edge of the second longitudinal sidewall 216 that is coupled to the second latitudinal sidewall 120. According to several exemplary embodiments, the one end of the first slot 226 extends to about the edge of the second longitudinal sidewall 216 which is coupled to the second latitudinal sidewall 120.

In certain exemplary embodiments, the second longitudinal sidewall 216 also includes an optional second slot 228. The second slot 228 is substantially angularly oriented with respect to the first slot 226. In one example, the second slot 228 is oriented at an angle of about thirty degrees with respect to the first slot 226; however, this angle ranges from about five degrees to about 175 degrees depending upon the orientation of the first slot 226. The second slot 228 also is recessed a desired depth into the second longitudinal sidewall 216, which is about the same depth that the first slot 226 is recessed according to certain exemplary embodiments. The second slot 228 is positioned to intersect approximately the end or the end of the first slot 226 that is positioned closer to the second latitudinal sidewall 120. According to some exemplary embodiments, a portion of the second slot 228 extends above the first slot 226, while a portion of the second slot 228 extends below the first slot 226. The second slot 228 is formed to smoothly transition into the first slot 226.

A second protrusion 229 extends outwardly from the second longitudinal sidewall 216 at the intersection of the first slot 226 and the second slot 228. The second protrusion 229 extends in a direction that is substantially perpendicular to the second longitudinal sidewall 216. The second protrusion 229 includes a mounting portion 298 and an engagement portion 299. The mounting portion 298 is cylindrically shaped and extends from the second longitudinal sidewall 216 to the engagement portion 299. Although the mounting portion 298 is cylindrically shaped, the mounting portion 298 is shaped in a different geometric or non-geometric shape in alternative exemplary embodiments. The engagement portion 299 is coupled to the end of the mounting portion 298 and is shaped into a round disk; however, the shape is different in other exemplary embodiments. The engagement portion 299 has a larger circumference than the mounting portion 298.

The upper cover 130 is coupled along the upper edges of at least one of the first longitudinal sidewall 114, the second longitudinal sidewall 216, the first latitudinal sidewall 118, and the second latitudinal sidewall 120. According to some exemplary embodiments, the upper cover 130 is friction fitted along each of the upper edges of the first longitudinal sidewall 114, the second longitudinal sidewall 216, the first latitudinal sidewall 118, and the second latitudinal sidewall 120. However, in other exemplary embodiments, the upper cover 130 is coupled to the upper edges of at least one of the first longitudinal sidewall 114, the second longitudinal sidewall 216, the first latitudinal sidewall 118, and the second latitudinal sidewall 120 using suitable fastening devices known to persons having ordinary skill in the art, such as hinges. The upper cover 130 is removable or at least partially removable from the body 110 according to some exemplary embodiments. The upper cover 130 is formed with an opening (not shown) therein and includes a lid 132 covering the opening according to certain exemplary embodiments. The lid 132 is pivotally or slidably coupled to the upper cover 130 so that it is movable to an open position to insert and/or remove contents from the cavity and movable to a closed position to encapsulate and/or thermally isolate the contents within the cavity. The lid 132 is shaped to cover the entire opening and is coupled to the upper cover 130 using hinges, pins, sliding rails, or other suitable fastening devices known to persons having ordinary skill in the art. According to some exemplary embodiments, the upper cover 130 is movable to an open position to insert and/or remove contents from the cavity and movable to a closed position to encapsulate and/or thermally isolate the contents within the cavity.

The wheel assembly 140 includes a first wheel 142 and a second wheel 144. According to some exemplary embodiments, the wheel assembly 140 includes an axle 146 extending from the first wheel 142 to the second wheel 144. According to certain exemplary embodiments, the first wheel 142 is positioned at least partially within the first recess 122 and the second wheel 144 is positioned at least partially within the second recess 224. Once the wheels 142, 144 are coupled to the body 110, the wheels 142, 144 extend below the base 112 according to some exemplary embodiments. A portion of the axle 146 is disposed within the body 110 according to some exemplary embodiments or can be inserted into a groove (not shown) formed within the outer wall of the base 112. The first and second wheels 142, 144 are configured to rotate, thereby facilitating in rolling the insulated cooler 100 from one location to another location. Although the first and second wheels 142, 144 are positioned at least partially within the first recess 122 and the second recess 224, respectively, the first and second wheels 142, 144 are not positioned within the first recess 122 and the second recess 224 according to some other exemplary embodiments, especially when recesses 122, 224 are not formed. Although certain exemplary embodiments have the axle 146 extending from the first wheel 142 to the second wheel 144, the axle 146 extends from one of the wheels 142, 144 to an adjacent portion of the body 110. Thus, each of the wheels 142, 144 are coupled to body 110 and are not coupled to one another. The outer circumference of the wheels 142, 144 are fabricated using rubber, plastic, metal, or any other suitable material known to persons having ordinary skill in the art.

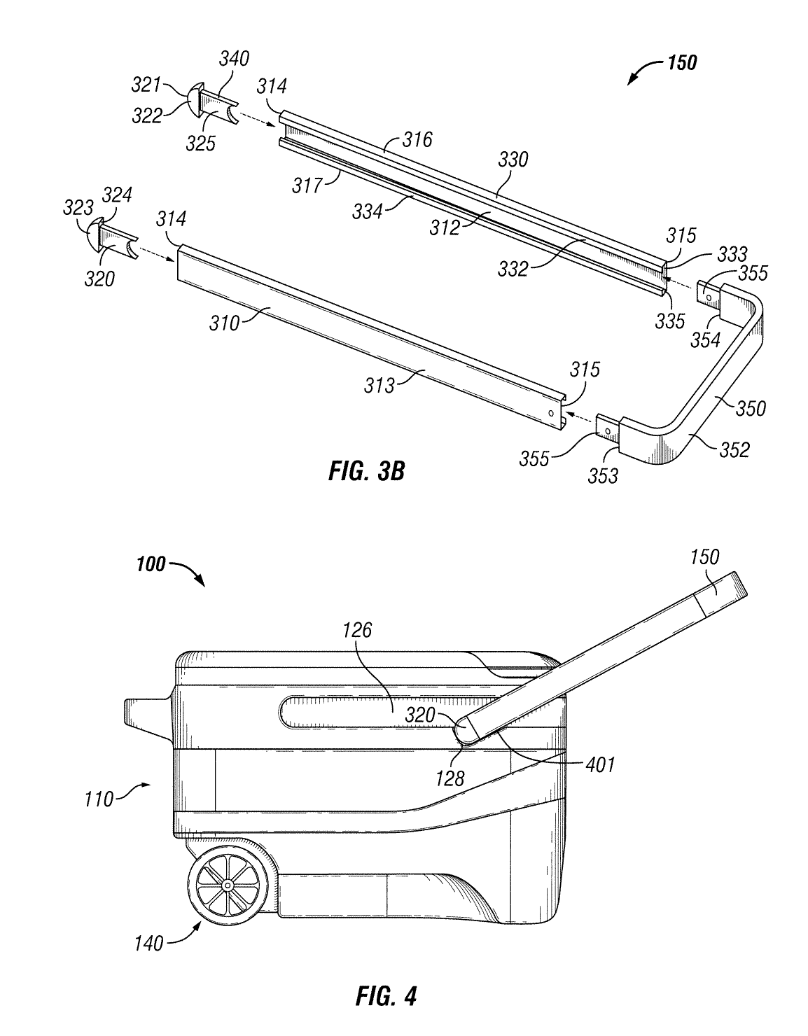

The handle 150 is securely and slidably coupled within the first slot 126 of the first longitudinal sidewall 114 and the first slot 226 of the second longitudinal sidewall 216. The handle 150 is substantially U-shaped; however, the handle 150 is shaped in different shapes according to other exemplary embodiments. The handle 150 is fabricated using polymers, metals, or any other suitable material or combination of materials. The handle 150 is discussed in further detail with respect to FIGS. 3A and 3B.

FIG. 3A is a perspective view of the handle 150 of the insulated cooler 100 of FIG. 1A according to the exemplary embodiment of the present invention. FIG. 3B is an exploded view of the handle 150 according to the exemplary embodiment of the present invention. Referring to FIGS. 3A and 3B, the handle 150 includes a first sidebar 310, a first stop cap 320, a second sidebar 330, a second stop cap 340, and a center bar 350. The first and second sidebars 310, 330 are similarly formed and therefore will be described together. Similarly, the first and second stop caps 320, 340 are similarly formed and therefore will also be described together.

Each of the first and second sidebars 310, 330 includes an interior side 312, an exterior side 313, a first end 314, a second end 315 opposite the first end 314, a top edge 316 extending from the first end 314 to the second end 315, and a bottom edge 317 also extending from the first end 314 to the second end 315 and located opposite the top edge 316. The interior side 312 is positioned adjacent to the body 110 (FIG. 1A) once the handle 150 is coupled to the body 110 (FIG. 1A), while the exterior side 313 faces away from the body 110 (FIG. 1A) once the handle 150 is coupled to the body 110 (FIG. 1A). Each of the first and second sidebars 310, 330 also include atop rail 332 and a bottom rail 334. The top rail 332 extends from the top edge 316 towards the bottom edge 317 adjacent to the interior side 312, whereby a top gap 333 is formed between the interior side 312 and the top rail 332. The bottom rail 334 extends from the bottom edge 317 towards the top edge 316 adjacent to the interior side 312, whereby a bottom gap 335 is formed between the interior side 312 and the bottom rail 334. The distance formed between the lower edge of the top rail 332 and the upper edge of the bottom rail 334 is sized to accommodate the fitting of the mounting portions 298 (FIG. 2) of the first protrusion and the second protrusion 229 (FIG. 2), which extend from the body 110 (FIG. 1A) and between the top and bottom rails 332, 334 once the handle 150 is coupled to the body 110 (FIG. 1A). The top and bottom gaps 333, 335 is sized to accommodate the fitting of the engagement portions 299 (FIG. 2) of the first protrusion and the second protrusion 229 (FIG. 2), which lies between the interior side 312 and the top and bottom rails 332, 334 once the handle 150 is coupled to the body 110 (FIG. 1A). The procedure in which the handle 150 is coupled to the body will be described in further detail below upon completing the description of one exemplary embodiment of the handle 150.

Each of the first and second stop caps 320, 340 includes a first portion 321 and a second portion 325 extending outwardly form the first portion 321. The first portion 321 includes an interior side 322, an exterior side 323, and a base portion 324 that extends from the interior side 322 to the exterior side 323. The interior side 322 is substantially planar according to some exemplary embodiments; however, the interior side is not substantially planar in other exemplary embodiments. The exterior side 323 is shaped similarly to the exterior side 313 of the first and second sidebars 310, 330; however the exterior side 323 is shaped differently than the exterior side 313 of the first and second sidebars 310, 330 in other exemplary embodiments. The base portion 324 is substantially planar in some exemplary embodiments; however, the base portion 324 is not substantially planar according to certain other exemplary embodiments.

The second portion 325 extends outwardly from the base portion 324 in a manner that is substantially perpendicular to the base portion 324. The second portion 325 is shaped to be inserted into both the top and bottom gaps 333, 335 from the first edge 314 of a respective first and second sidebars 310, 330, such that one of the surfaces of the second portion 325 is adjacent to the interior side 312. According to one exemplary embodiment, the second portion 325 is friction fitted into the top and bottom gaps 333, 335. In another exemplary embodiment, a fastening device (not shown), such as a screw and bolt, is used to couple the second portion 325 to one of the first and second sidebars 310, 330 within both the top and bottom gaps 333, 335. Other methods known to persons having ordinary skill in the art having the benefit of the present disclosure can be used to couple the first and second stop caps 320, 340 to the respective first and second sidebars 310, 330 in other exemplary embodiments. Once inserted into the first and second gaps 333, 335, the second portion 225 in conjunction with the first and second protrusions 229 (FIG. 2) provide a stop mechanism for the handle 150 when the handle 150 is slid along the first slot 126, 226 (FIGS. 1 and 2). A distal edge 326 of the second portion 325 is shaped in accordance with the outer corresponding shape of the mounting portions 298 (FIG. 2) according to some exemplary embodiments that utilize the second slot 128, 228 (FIGS. 1 and 2). For example, if the mounting portion 298 (FIG. 2) has an arcuate shape, the distal edge 326 also has an arcuate shape that mates with the mounting portion 298 (FIG. 2). This shape of the distal edge 326 allows the first and second sidebars 310, 330 to pivot from the first slot 126, 226 (FIGS. 1 and 2) to the second slot 128, 228 (FIGS. 1 and 2) when desired.

The center bar 350 is substantially U-shaped and extends from the second end 315 of the first sidebar 310 to the second end 313 of the second side bar 330 once coupled to the first and second sidebars 310, 330. Although the center bar 350 is substantially U-shaped, the center bar 350 is shaped in other geometric or non-geometric shapes in other exemplary embodiments. The center bar 350 includes a bar portion 352 and a coupling portion 355 extending from each end 353, 354 of the bar portion 352. According to some exemplary embodiments, the bar portion 352 is substantially U-shaped; however, the bar portion 352 is shaped in other geometric or non-geometric shapes in other exemplary embodiments. The coupling portion 355 extends outwardly from each of the ends 353, 354 and is shaped to be inserted into both the top and bottom gaps 333, 335 from the second end 315 of a respective first and second sidebars 310, 330, such that one of the surfaces of the coupling portion 355 is adjacent to the interior side 312. According to one exemplary embodiment, the coupling portion 355 is friction fitted into the top and bottom gaps 333, 335. In another exemplary embodiment, a fastening device (not shown), such as a screw and bolt, is used to couple the coupling portion 355 to one of the first and second sidebars 310, 330 within both the top and bottom gaps 333, 335. Other methods known to persons having ordinary skill in the art having the benefit of the present disclosure can be used to couple the coupling portions 355 to the respective first and second sidebars 310, 330 in other exemplary embodiments. Although the center bar 350 has been shown to be fabricated separately from the first and second sidebars 310, 330, one or more of the center bar 350 and the first and second sidebars 310, 330 are integrally formed as a single component according to other exemplary embodiments.

Referring to FIGS. 1A-3B, the method for coupling the handle 150 to the body 110 is described. The first edge 314 of the first sidebar 310 is positioned substantially adjacent to the first protrusion of the first longitudinal sidewall 114 and is horizontally aligned with the first protrusion. The first sidebar 310 is positioned substantially parallel to the first slot 126. The first sidebar 310 is moved towards the first protrusion and continues being moved so that the first protrusion is coupled to the first sidebar 310. Specifically, the mounting portion is inserted between the top rail 332 and the bottom rail 334 and the engagement portion is inserted within the top and bottom gap 333, 335 formed between the top and bottom rails 332, 334 and the interior side 312 of the first sidebar 310. Thus, the first sidebar 310 is partially inserted into the first slot 126. Once the first protrusion is coupled to the first sidebar 310, the first sidebar 310 is slid further along the first slot 126. The first stop cap 320 is then coupled to the first edge 314 by inserting the second portion 325 of the first stop cap 320 within the top and bottom gap 333, 335 formed between the top and bottom rails 332, 334 and the interior side 312 of the first sidebar 310. Thus, the first sidebar 310 along with the first stop cap 320 are coupled to the first longitudinal sidewall 114 within the first slot 126. A similar method is used to couple the second sidebar 330 and the second stop cap 340 to the second longitudinal sidewall 216 within the first slot 226. Once the first and second sidebars 310, 330 and the first and second stop caps 320, 340 are coupled to the respective first and second longitudinal sidewalls 114, 216, each coupling portion 355 of the center bar 350 is coupled to a respective second edge 315 of the first and second sidebars 310, 330 according to the description provided above. Although the center bar 350 is coupled to the second edge 315 of the first and second sidebars 310, 330 at the end of the process according to some exemplary embodiments, the center bar 350 is coupled to at least one of the first and second sidebars 310, 330 during the beginning of the method or at any intermediate step in the process.

Operability of the insulated cooler's handle 150 is described while referencing FIGS. 1A-4. FIG. 4 is a side view of the insulated cooler 100 with the handle 150 being in an extended and tilted position 401 according to the exemplary embodiment of the present invention. Referring to FIGS. 1A-4, the handle 150 is positioned in a retracted position 101 as shown in FIGS. 1A and 1B. The retracted position 101 is the position that the handle 150 normally is in when the insulated cooler 100 is not being moved. Thus, the handle 150 does not create a hazard to nearby people during these times. When a user desires to move the insulated cooler 100 using the wheel assembly 140, the user slides the handle 150 such that the first and second sidebars 310, 330 move along and within the respective first slot 126, 226 and the center bar 350 is moved further away from the body 110. In certain exemplary embodiments, the horizontal component of the distance between the center bar 350 and the second latitudinal sidewall 120 is lesser when the handle 150 is positioned in the retracted position 101 than when the handle is positioned in the extended and/or extended and tilted position 401. In certain exemplary embodiments, the length of the handle 150 between the center bar 350 and the second latitudinal sidewall 120 is greater than the vertical height of the second latitudinal sidewall 120 when the handle 150 is positioned in the extended and/or extended and tilted position 401. The handle 150 is fully extended when the first and second stop caps 320, 340 engage with the respective first and second protrusions 229. According to some exemplary embodiments which do not include the second slots 128, 228, the user can lift one end of the insulated cooler 100 by lifting the handle 150, i.e. exerting a force on the handle, and then moving the insulated cooler 100 from the first location to a second location. The force the user exerts on the center bar 350 of the handle 150 is less when the handle 150 is extended because the handle 150 functions as a lever and the wheel assembly 140 functions as a fulcrum. The wheel assembly 140 is considered the fixed point at which the insulated cooler 100 rotates once the force is applied onto the handle 150. Thus, in some exemplary embodiments, the center of mass of the insulated cooler 100 is positioned between the wheel assembly 140 and the point at which the force is exerted onto the handle 150. However, the wheel assembly 140 is moved closer to the center of mass of the insulated cooler 100 or even at the position of the center of mass of the insulated cooler 100 according to certain alternative exemplary embodiments. The closer the wheel assembly 140 is to the center of mass of the insulated cooler 100, the less force the user exerts onto the handle 150 to move the insulated cooler 100.

In the exemplary embodiments where the second slots 128, 228 are included, once the handle 150 is fully extended as described above, the handle 150 is tilted so that the first and second stop caps 320, 340 and a portion of each of the first and second sidebars 310, 330 are transitioned into the respective second slot 128, 228. This transition occurs when the first and second sidebars 310, 330 pivot around the respective first and second protrusions 229. FIG. 4 illustrates the handle 150 being in this extended and tilted position 401. Once the handle 150 is in the extended and tilted position 401, the user exerts force similar to the force as exerted in the previously described exemplary embodiment. The embodiment having the extended and tilted position 401 accommodates both short and tall users as the previously described exemplary embodiment, having only the extended position, can cause a very tall user to exert more force on the handle 150 since the very tall user may have to lift the handle 150 a greater vertical distance.

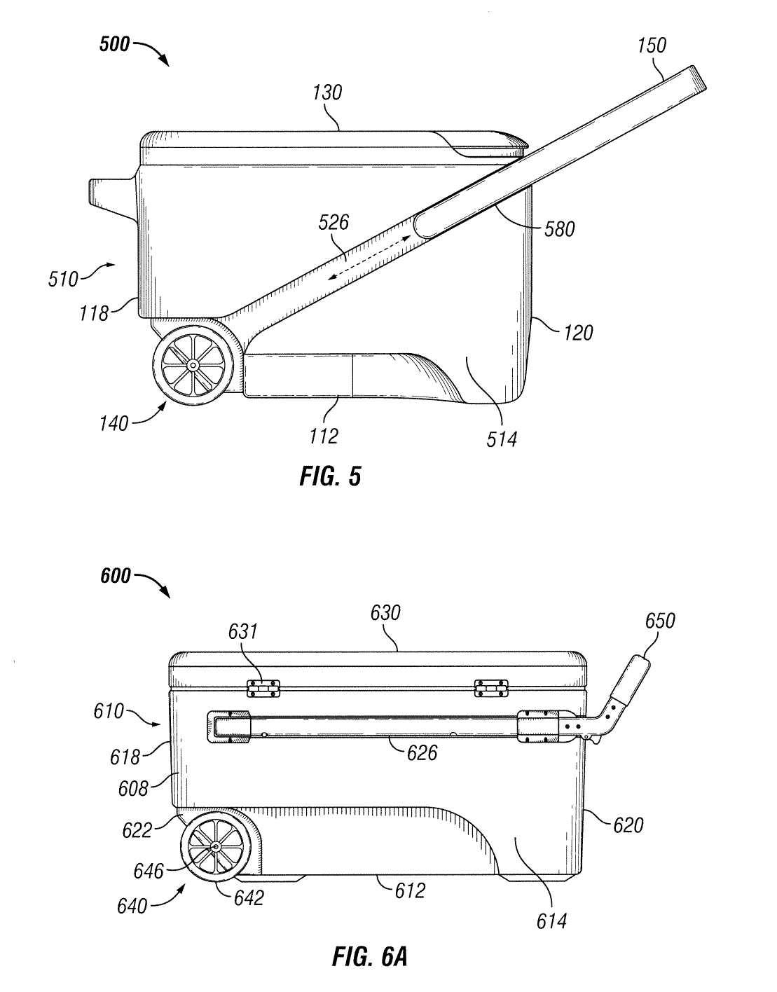

FIG. 5 is a side view of an insulated cooler 500 according to a second exemplary embodiment of the present invention. The insulated cooler 500 is similar to insulated cooler 100 (FIG. 1A) and includes a body 510, an upper cover 130, a wheel assembly 140, and a handle 150. The upper cover 130, the wheel assembly 140, and the handle 150 have been previously described and therefore will not be described in duplicate again.

The body 510 is similar to the body 110 (FIG. 1A) and includes the base 112, a first longitudinal sidewall 514, a second longitudinal sidewall (not shown), a first latitudinal sidewall 118, and a second latitudinal sidewall 120. The base 112, the first latitudinal sidewall 118, and the second latitudinal sidewall 120 have been previously described and therefore will not be described in duplicate again. The body 510 also is assembled in a similar manner to the body 110 (FIG. 1A). The difference between the body 510 and the body 110 (FIG. 1A) is in the construction of the first and second longitudinal sidewalls 514. Since the first and second longitudinal sidewalls 514 are similar to one another, the first and second longitudinal sidewalls 514 are described with respect to the first longitudinal sidewall 514 only.

The first longitudinal sidewall 514 includes a first slot 526 and is constructed similarly to the first longitudinal sidewall 114 (FIG. 1A), except for the positioning of the first slot 526. The first slot 526 is positioned angularly when compared to the positioning of the first slot 126 (FIG. 1A). According to some exemplary embodiments, the first slot 526 extends substantially diagonally across the first longitudinal sidewall 514, which extends from about where the wheel assembly 140 is positioned to an opposite diagonal end 580 of the first longitudinal sidewall 514. In one example, the first slot 526 is formed at about a thirty degree angle when measured from the horizontal. The first longitudinal sidewall 514 includes similar features as the first longitudinal sidewall 114 (FIG. 1A), such as the first protrusion (not shown). In other exemplary embodiments, the first slot 526 extends from the opposite diagonal end 580 angularly towards the wheel assembly 140, but does not extend entirely to the wheel assembly 140. In certain other exemplary embodiments, the first slot 526 extends from substantially the opposite diagonal end 580 at an angle ranging from about zero degrees to less than ninety-degrees when measured from the horizontal. The handle 150 is partially fitted within the first slot 526 according to the description provided above and operates in a manner similar to the manner previously described with respect to insulated cooler 100 (FIG. 1A).

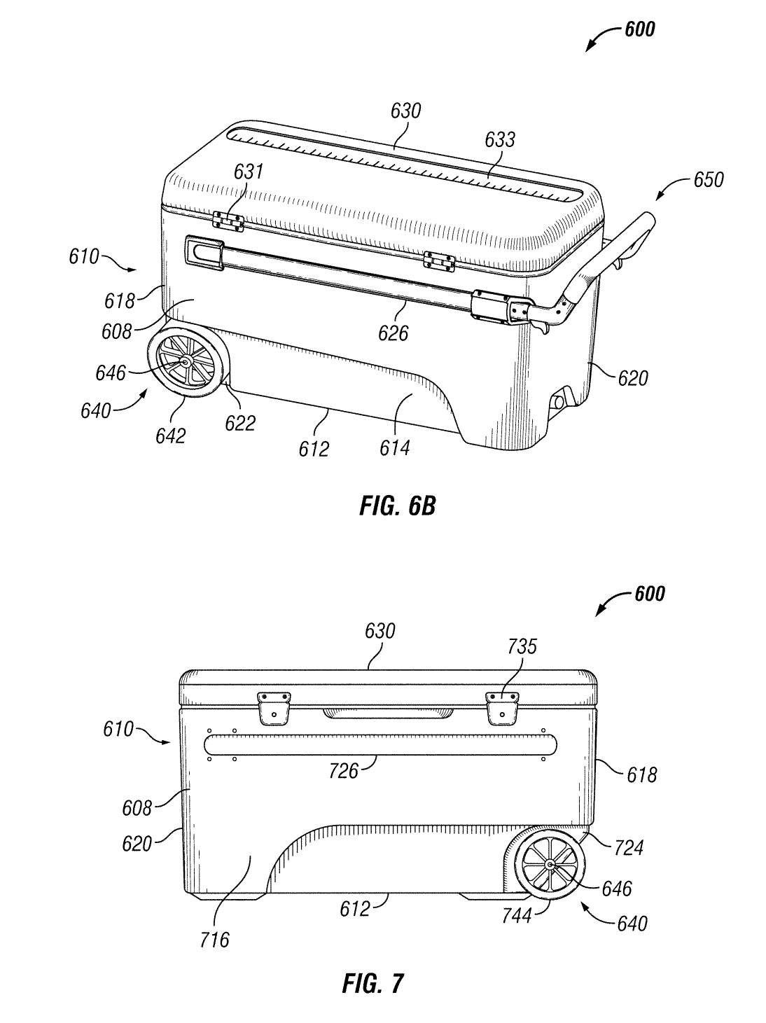

FIGS. 6A and 6B are various views of an insulated cooler 600 according to an exemplary embodiment of the present invention. FIG. 7 is a side view of the insulated cooler 600 with a handle 650 being removed according to the exemplary embodiment of the present invention Referring to FIGS. 6A, 6B and 7, the insulated cooler 600 includes a body 610, an upper cover 630, a wheel assembly 640, and a handle 650. The insulated cooler 600 generally is rectangularly shaped; however, the insulated cooler 600 is shaped in other geometric or non-geometric shapes in alternative exemplary embodiments.

The body 610 includes a base 612, a first longitudinal sidewall 614, a second longitudinal sidewall 716, a first latitudinal sidewall 618, and a second latitudinal sidewall 620. The first longitudinal sidewall 614 and the second longitudinal sidewall 716 both extend upwardly from the base 612 at opposing edges of the base 612 such that the first longitudinal sidewall 614 and the second longitudinal sidewall 716 are substantially parallel to one another. However, in other exemplary embodiments, the first longitudinal sidewall 614 and the second longitudinal sidewall 716 are not substantially parallel to one another. Similarly, the first latitudinal sidewall 618 and the second latitudinal sidewall 620 both extend upwardly from the base 612 at opposing edges of the base 612 such that the first latitudinal sidewall 618 and the second latitudinal sidewall 620 are substantially parallel to one another and substantially perpendicular to each of the first longitudinal sidewall 614 and the second longitudinal sidewall 716. However, in other exemplary embodiments, the first latitudinal sidewall 618 and the second latitudinal sidewall 620 are not substantially parallel to one another and are not substantially perpendicular to each of the first longitudinal sidewall 614 and the second longitudinal sidewall 716. The base 612, the first longitudinal sidewall 614, the second longitudinal sidewall 716, the first latitudinal sidewall 618, and the second latitudinal sidewall 620 are coupled to one another to define a cavity (not shown) formed therein. In certain exemplary embodiments, the first and second longitudinal sidewalls 614, 716 become the first and second latitudinal sidewalls 618, 620, respectively, and the first and second latitudinal sidewalls 618, 620 become the first and second longitudinal sidewalls 614, 716, respectively.

Each of the base 612, the first longitudinal sidewall 614, the second longitudinal sidewall 716, the first latitudinal sidewall 618, and the second latitudinal sidewall 620 includes an outer wall 608 exposed to the outside environment and an inner wall (not shown) which surrounds the cavity. An insulation (not shown), such as Styrofoam®, is disposed between the outer wall 608 and the inner wall to facilitate in keeping the contents placed within the cavity cooler for a longer time period than if insulation were not provided. The outer wall 608 of each of the base 612, the first longitudinal sidewall 614, the second longitudinal sidewall 716, the first latitudinal sidewall 618, and the second latitudinal sidewall 620 are coupled together. In one exemplary embodiment, the outer wall 608 of each of base 612, the first longitudinal sidewall 614, the second longitudinal sidewall 716, the first latitudinal sidewall 618, and the second latitudinal sidewall 620 are molded together as a uniform component. Similarly, the inner wall of each of the base 612, the first longitudinal sidewall 614, the second longitudinal sidewall 716, the first latitudinal sidewall 618, and the second latitudinal sidewall 620 are coupled together. In one exemplary embodiment, the inner wall of each of base 612, the first longitudinal sidewall 614, the second longitudinal sidewall 716, the first latitudinal sidewall 618, and the second latitudinal sidewall 620 are molded together as a uniform component. According to one exemplary embodiment, the outer wall 608 is fabricated using a polymer material; however, other suitable materials known to persons having ordinary skill in the art can be used without departing from the scope and spirit of the exemplary embodiment. Similarly, according to one exemplary embodiment, the inner wall also is fabricated using a polymer material; however, other suitable materials known to persons having ordinary skill in the art can be used without departing from the scope and spirit of the exemplary embodiment.

According to certain exemplary embodiments, the base 612, the first longitudinal sidewall 614, and the first latitudinal sidewall 618 are shaped and coupled to one another to form a first recess 622 substantially where each of the base 612, the first longitudinal sidewall 614, and the first latitudinal sidewall 618 couple to one another. The first recess 622 is formed at an exterior portion of the body 610. Although the first recess 622 is formed in some exemplary embodiments, the first recess 622 is formed at a different location of approximately where at least the base 612 and the first longitudinal sidewall 614 are coupled to one another or is not formed altogether according to certain exemplary embodiments. For example, the first recess 622 is formed substantially half-way the longitudinal length of the first longitudinal sidewall 614 in certain exemplary embodiments. A second recess 724, similar to the first recess 622, is formed at another portion of the base 610. In one example, the second recess 724 is formed substantially where each of the base 612, the second longitudinal sidewall 716, and the first latitudinal sidewall 618 couple to one another. The second recess 724 also is formed at an exterior portion of the body 610. Although the second recess 724 is formed in some exemplary embodiments, the second recess 724 is formed at a different location of approximately where at least the base 612 and the second longitudinal sidewall 716 are coupled to one another or is not formed altogether according to certain exemplary embodiments. For example, the second recess 724 is formed substantially half-way the longitudinal length of the second longitudinal sidewall 716 in certain exemplary embodiments.

The first longitudinal sidewall 614 also includes a slot 626. The slot 626 is substantially horizontally oriented, which is at about zero degrees to the horizontal, and is recessed a desired depth into the first longitudinal sidewall 614. In certain exemplary embodiments, however, the slot 626 is not horizontally oriented. The slot 626 is positioned in the upper portion of the first longitudinal sidewall 614 according to some exemplary embodiments. In certain exemplary embodiments, the slot 626 is positioned near the top edge of the first longitudinal sidewall 614. However, in certain exemplary embodiments, the slot 626 is not positioned in the upper portion of the first longitudinal sidewall 614. The slot 626 extends a portion of the length of the first longitudinal sidewall 614; however, the slot 626 extends substantially the entire length of the first longitudinal sidewall 614 in other exemplary embodiments, which is from about the edge of the first longitudinal sidewall 614 that is coupled to the first latitudinal sidewall 618 to about the edge of the first longitudinal sidewall 614 that is coupled to the second latitudinal sidewall 620. According to several exemplary embodiments, one end of the slot 626 extends to about the edge of the first longitudinal sidewall 614 which is coupled to the second latitudinal sidewall 620.

The second longitudinal sidewall 716 also includes a slot 726. The slot 726 is substantially horizontally oriented, which is at about zero degrees to the horizontal, and is recessed a desired depth into the second longitudinal sidewall 716. In certain exemplary embodiments, however, the slot 726 is not horizontally oriented. The slot 726 is positioned in the upper portion of the second longitudinal sidewall 716 according to some exemplary embodiments. In certain exemplary embodiments, the slot 726 is positioned near the top edge of the second longitudinal sidewall 716. However, in certain exemplary embodiments, the slot 726 is not positioned in the upper portion of the second longitudinal sidewall 716. The slot 726 extends a portion of the length of the second longitudinal sidewall 716; however, the slot 726 extends substantially the entire length of the second longitudinal sidewall 716 in other exemplary embodiments, which is from about the edge of the second longitudinal sidewall 716 that is coupled to the first latitudinal sidewall 618 to about the edge of the second longitudinal sidewall 716 that is coupled to the second latitudinal sidewall 620. According to several exemplary embodiments, one end of the slot 726 extends to about the edge of the second longitudinal sidewall 716 which is coupled to the second latitudinal sidewall 620.

The upper cover 630 is coupled along the upper edges of at least one of the first longitudinal sidewall 614, the second longitudinal sidewall 716, the first latitudinal sidewall 618, and the second latitudinal sidewall 620. According to some exemplary embodiments, the upper cover 630 is friction fitted along each of the upper edges of the first longitudinal sidewall 614, the second longitudinal sidewall 716, the first latitudinal sidewall 618, and the second latitudinal sidewall 620. However, in other exemplary embodiments, the upper cover 630 is coupled to the upper edges of at least one of the first longitudinal sidewall 614, the second longitudinal sidewall 716, the first latitudinal sidewall 618, and the second latitudinal sidewall 620 using suitable fastening devices 631 known to persons having ordinary skill in the art, such as hinges. The upper cover 630 is removable or at least partially removable from the body 610 according to some exemplary embodiments. Although not illustrated in this exemplary embodiment, the upper cover 630 is formed with an opening (not shown) therein and includes a lid (not shown) covering the opening according to certain exemplary embodiments. The lid is pivotally or slidably coupled to the upper cover 630 so that it is opened to insert and/or remove contents from the cavity and closed to encapsulate the contents within the cavity. The lid is shaped to cover the entire opening and is coupled to the upper cover 630 using hinges, pins, sliding rails or other suitable fastening devices known to persons having ordinary skill in the art. According to some exemplary embodiments, a measuring device 633 is coupled to or formed onto the upper cover 630. In one example, the measuring device 633 is adhesively affixed to an outer surface of the upper cover 630. In another example, the measuring device 633 is molded within the upper surface of the upper cover 630 so that it is not worn away through use or does not become separated from the upper cover 630. Although, the measuring device 633 is affixed to the outer surface of the upper cover 630, the measuring device 633 can be affixed to any portion of the insulated cooler 600 in other exemplary embodiments. Although some methods for affixing the measuring device 633 to the insulated cooler 600 is described, other methods known to people having ordinary skill in the art can be used without departing from the scope and spirit of the exemplary embodiment. According to certain exemplary embodiments, the upper cover 630 also includes one or more locking mechanisms 735 coupled along one or more edges of the upper cover 630. The locking mechanisms 735 are known to persons having ordinary skill in the art and are used to fasten a portion of the upper cover 630 to the body 610 so that the upper cover 630 is not inadvertently opened. The locking mechanism 735 is a snap lock according to one exemplary embodiment; however, other known locking mechanisms can be utilized, including, but not limited to key locks and sliding locks.

The wheel assembly 640 includes a first wheel 642 and a second wheel 744. According to some exemplary embodiments, the wheel assembly 640 includes an axle 646 extending from the first wheel 642 to the second wheel 744. According to certain exemplary embodiments, the first wheel 642 is positioned at least partially within the first recess 622 and the second wheel 744 is positioned at least partially within the second recess 724. Once the wheels 642, 744 are coupled to the body 610, the wheels 642, 744 extend below the base 612 according to some exemplary embodiments. A portion of the axle 646 is disposed within the body 610 according to some exemplary embodiments or can be inserted into a groove (not shown) formed within the outer wall of the base 612. The first and second wheels 642, 744 are configured to rotate, thereby facilitating in rolling the insulated cooler 600 from one location to another location. Although the first and second wheels 642, 744 are positioned at least partially within the first recess 622 and the second recess 724, respectively, the first and second wheels 642, 744 are not positioned within the first recess 622 and the second recess 724 according to some other exemplary embodiments, especially when recesses 622, 724 are not formed. Although certain exemplary embodiments have the axle 646 extending from the first wheel 642 to the second wheel 744, the axle 646 extends from one of the wheels 642, 744 to an adjacent portion of the body 610. Thus, each of the wheels 642, 744 are coupled to body 610 and are not coupled to one another. The outer circumference of the wheels 642, 744 are fabricated using rubber, plastic, metal, or any other suitable material known to persons having ordinary skill in the art.

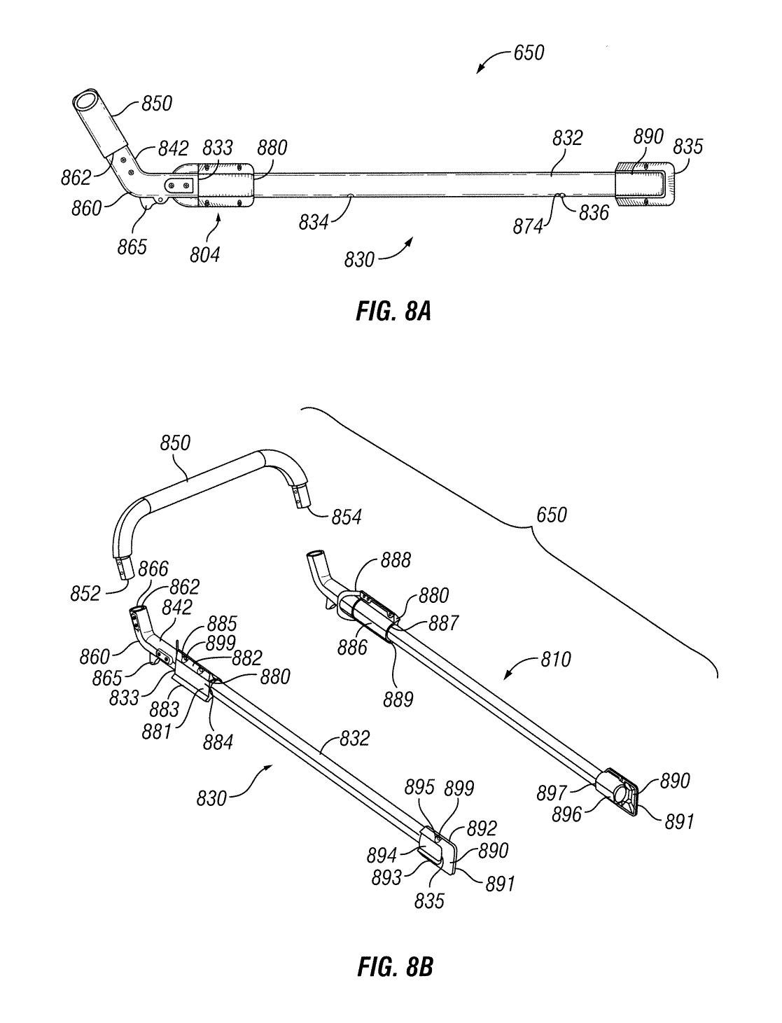

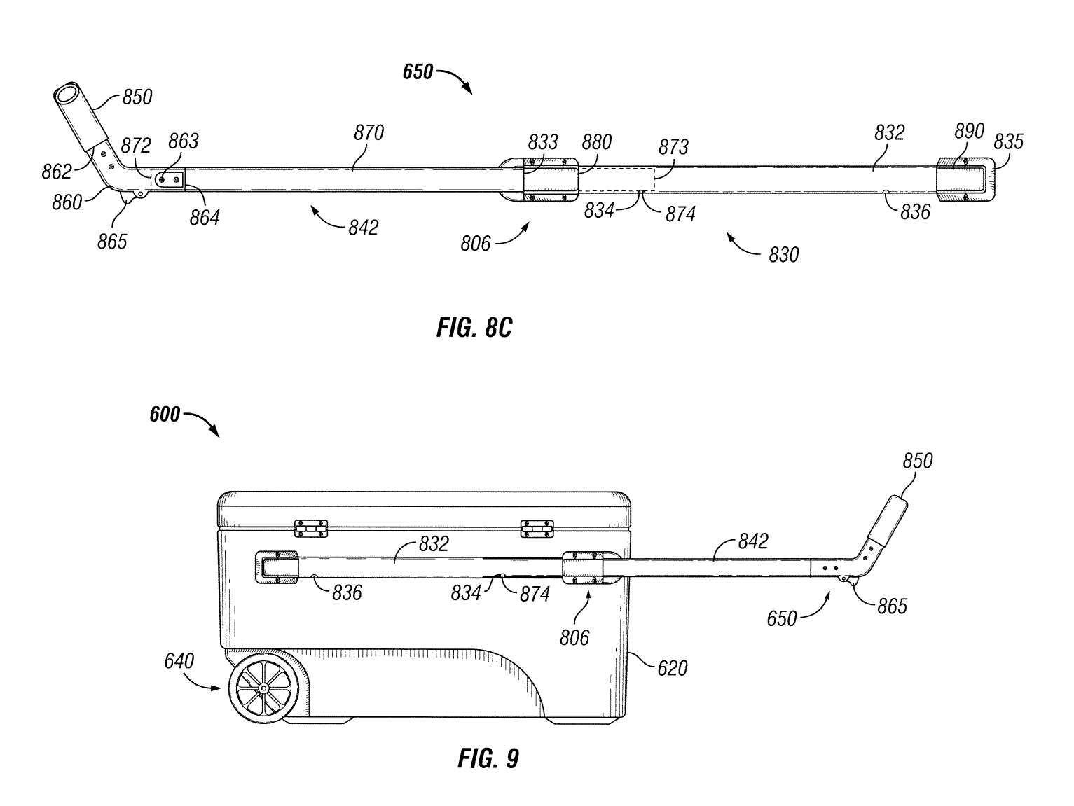

The handle 650 is securely and telescopingly coupled within the slot 626 of the first longitudinal sidewall 614 and the slot 726 of the second longitudinal sidewall 716. The handle 650 is substantially U-shaped; however, the handle 650 is shaped in different shapes according to other exemplary embodiments. The handle 650 is fabricated using polymers, metals, or any other suitable material or combination of materials. The handle 650 is discussed in further detail with respect to FIGS. 8A, 8B, and 8C.

FIG. 8A is a side view of the handle 650 of the insulated cooler 600 of FIG. 6A in a retracted position 804 according to the third exemplary embodiment of the present invention. FIG. 8B is an exploded view of the handle 650 according to the third exemplary embodiment of the present invention. FIG. 8C is a side view of the handle 650 in an extended position 806 according to the third exemplary embodiment of the present invention Referring to FIGS. 8A, 8B, and 8C, the handle 650 includes a first sidebar 810, a second sidebar 830, and a center bar 850. The first and second sidebars 810, 830 are similarly formed and therefore will be described with respect to the second sidebar 830 only.

The second sidebar 830 includes an outer tubular member 832 and an inner tubular member 842. The outer tubular member 832 is substantially linear in shape and includes a first end 833 and a second end 835 located at an opposing end from the first end 833. The first end 833 forms an opening (not shown) which extends into the outer tubular member 832 and towards the second end 835. According to some exemplary embodiments, the opening extends substantially to the second end 835. In certain exemplary embodiments, the outer tubular member 832 includes a first aperture 834 positioned nearer the first end 833. The first aperture 834 extends from an outer surface of the outer tubular member 832 and into the opening formed within the outer tubular member 832. The outer tubular member 832 also includes a second aperture 836 positioned nearer the second end 835. The second aperture 836 also extends from an outer surface of the outer tubular member 832 and into the opening formed within the outer tubular member 832. Both the first and second apertures 834, 836 are formed in alignment with one another. For example, when the first aperture 834 is formed on the top side of the outer tubular member 832 nearer the first end 833, the second aperture 836 also is formed on the top side of the outer tubular member 832 nearer the second end 835. Conversely, when the first aperture 834 is formed on the bottom side of the outer tubular member 832 nearer the first end 833, the second aperture 836 also is formed on the bottom side of the outer tubular member 832 nearer the second end 835.

The inner tubular member 842 includes a first portion 860 coupled to a second portion 870. The second portion 870 includes a first end 872 and a second end 873 located at an opposing end from the first end 872 and is shaped similarly to the shape of the outer tubular member 832; however, the outer circumference of the second portion 870 is smaller than the inner circumference of the outer tubular member 832. Once the second sidebar 830 is assembled, the second portion 870 is at least partially inserted into and slidably and securely coupled within the opening formed within the outer tubular member 832. Specifically, the second end 873 of the inner tubular member 842 is inserted into the first end 833 of the outer tubular member 832 and slidably coupled therein. A channel (not shown) is formed extending from the first end 872 towards the second end 873 and houses at least a portion of a cable wire (not shown), which is described in further below. Additionally, a cavity (not shown) is formed adjacent the second end and is communicably coupled to the channel. A locking pin 874 is inserted into the cavity and is coupled to one end of the cable wire.

The first portion 860 is tubular in shape and includes a first end 862 and a second end 864 positioned at an opposing end from the first end 862. According to some exemplary embodiments, the first end 862 is positioned at an angle with respect to the positioning of the second end 864. Thus, in one example, the first portion 860 is substantially V-shaped; however, the first portion 860 is shaped in different geometric or non-geometric shapes in other exemplary embodiments. The second end 864 forms an opening (not shown) that extends towards the first end 862. The second end 864 has a larger inner circumference than the outer circumference of the second portion's first end 872. Thus, the second portion's first end 872 is inserted into the second end 864 and coupled to one another using one or more fastening devices 863, such as a screw or a rivet. Hence, the opening formed at the second end 864 is communicably coupled to the channel formed at the second portion's first end 872. An actuator 865 is disposed on an outer surface of the first portion 860 between the first end 862 and the second end 864. In certain exemplary embodiments, the opening formed at the second end 864 extends to the actuator 865. Another end of the cable wire is coupled to the actuator 865. Thus, when the actuator 865 is activated, or depressed in certain exemplary embodiments, the locking pin 874 moves closer to the interior of the second portion 870. However, when the actuator 865 is not activated, or not depressed in certain exemplary embodiments, the locking pin 874 is biased in a direction that moves the locking pin 874 to a location that is at least partially outside the circumferential profile of the second portion 870. The first end 862 also forms an opening 866 which extends towards the actuator 865. The first end 862 is configured to be coupled to one end of the center bar 850.

The center bar 850 is substantially U-shaped and includes a first end 852 and a second end 854 located at an opposite end from the first end 852. Although the center bar 850 is substantially U-shaped, the center bar 850 is shaped in other geometric or non-geometric shapes in other exemplary embodiments. The first end 852 and the second end 854 of the center bar 850 are coupled respectively to each of the first ends 862 of the first and second sidebars' first portion 860. In one example, the first end 852 of the center bar 850 is coupled to the first end 862 of the second sidebar's first portion 860 by inserting the first end 852 into the opening 866 formed in the first end 862 of the second sidebar's first portion 860. The center bar 850 is coupled to the second sidebar 830 using fastening devices 853, such as screws, friction fitting, or by other methods known to people having ordinary skill in the art. Similarly, the second end 854 of the center bar 850 is coupled to the first sidebar 810 in a similar manner. Although the center bar 850 has been shown to be fabricated separately from the first and second sidebars 810, 830, one or more of the center bar 850 and the first and second sidebars 810, 830 are integrally formed as a single component according to other exemplary embodiments. Additionally, although one example has been described for assembling the telescoping handle 650, other methods known to persons having ordinary skill in the art having the benefit of the present disclosure can be used without departing from the scope and spirit of the exemplary embodiments.

Referring to FIGS. 6A-8C, one method and device for coupling the handle 650 to the body 810 is illustrated. According to one exemplary embodiment, the first sidebar 810 is inserted into the slot 626 of the first longitudinal sidewall 614 and the second sidebar 830 is inserted into the slot 726 of the second longitudinal sidewall 716. The center bar 850 is coupled to both the first sidebar 810 and the second sidebar 830 either before, during, or after one or both of the first sidebar 810 and/or the second sidebar 830 has been coupled to the respective slot 626, 726. The first sidebar 810 and the second sidebar 830 are secured within the respective slots 626, 726 using one or more brackets 880, 890. According to certain exemplary embodiments, a front bracket 880 and a rear bracket 890 are used to securely couple each of the first and second sidebars 810, 830 to the respective slots 626, 726; however, other known devices can be used without departing from the scope and spirit of the exemplary embodiment.

According to certain exemplary embodiments, the rear bracket 890 includes a base portion 891 and a tubular portion 896 extending outwardly and longitudinally adjacent to the base portion 891. The base portion 891 is substantially planar according to certain exemplary embodiments; however, the base portion 891 is not planar in other exemplary embodiments. The base portion 891 is rectangularly shaped and includes a longitudinally extending top portion 892, a longitudinally extending bottom portion 893, and a longitudinally extending center portion 894 positioned between the top portion 892 and the bottom portion 893. The base portion 891 includes one or more apertures 895 formed within the top portion 892 and the bottom portion 893. These apertures 895 are configured to receive a fastening device 899, such as a screw, for securely coupling either the first and second sidebars 810, 830 within the respective slots 626, 726. The tubular portion 896 is formed substantially adjacent the center portion 894 and includes a channel 897 extending from one edge of the tubular portion 896 towards the opposing edge of the tubular portion 896. The channel 897 is sized to accommodate the insertion of the second end 835 of the outer tubular member 832.

According to certain exemplary embodiments, the front bracket 880 includes a base portion 881 and a tubular portion 886 extending outwardly and longitudinally adjacent to the base portion 881. The base portion 881 is substantially planar according to certain exemplary embodiments; however, the base portion 881 is not planar in other exemplary embodiments. The base portion 881 is rectangularly shaped and includes a longitudinally extending top portion 882, a longitudinally extending bottom portion 883, and a longitudinally extending center portion 884 positioned between the top portion 882 and the bottom portion 883. The base portion 881 includes one or more apertures 885 formed within the top portion 882 and the bottom portion 883. These apertures 885 are configured to receive a fastening device 899, such as a screw, for securely coupling the first and second sidebars 810, 830 within the respective slots 626, 726. The tubular portion 886 is formed substantially adjacent the center portion 884 and includes a channel 887 extending from a first edge 888 of the tubular portion 886 to an opposing edge 889 of the tubular portion 886. The channel 887 is sized to accommodate the insertion of the outer tubular member 832. The first edge 888 is formed at an angle according to some exemplary embodiments to accommodate the coupling of the front bracket 880 in either slot 626, 726, adjacent to where the first or second longitudinal sidewall 614, 716 meets the second latitudinal sidewall 620.

The coupling of the first sidebar 810 to the first longitudinal sidewall 614 is similar to the coupling of the second sidebar 830 to the second longitudinal sidewall 716 and therefore will be explained only with respect to the coupling of the first sidebar 810 to the first longitudinal sidewall 614. The second end 835 of the outer tubular member 832 is inserted through the channel 887 formed in the front bracket 880 from the first edge 888. The second end 835 of the outer tubular member 832 also is inserted into the channel 897 formed in the rear bracket 890. The front bracket 880 is moved and positioned substantially at the first end 833 of the outer tubular member 832, while the rear bracket 890 is positioned substantially at the second end 835 of the outer tubular member 832. Once the brackets 880, 890 are assembled onto the outer tubular member 832, the tubular portions 886, 896 of the front and rear brackets 880, 890 are positioned within the slot 626 formed in the first longitudinal sidewall 614. Thus, the front bracket 880 is positioned on the first longitudinal sidewall 614 substantially near the second latitudinal sidewall 620, while the rear bracket 890 also is positioned on the first longitudinal sidewall 614, but substantially near the first latitudinal sidewall 618 according to certain exemplary embodiments. In short, the front bracket 880 is positioned further away from the wheel assembly 640 than the positioning of the rear bracket 890. Once properly aligned along the first longitudinal sidewall 614, the front and rear brackets 880, 890 are coupled to the first longitudinal sidewall 614 using fastening devices 899 being inserted though the apertures 885, 895. As previously mentioned, the second sidebar 830 is coupled to the second longitudinal sidewall 716 in a similar manner.

Operability of the insulated cooler's handle 650 is described while referencing FIGS. 6A-9. FIG. 9 is a side view of the insulated cooler 600 with the handle 650 being in an extended position 806 according to the third exemplary embodiment of the present invention. Referring to FIGS. 6A-9, the handle 650 is positioned in a retracted position 804 as shown in FIGS. 6A, 6B, and 8A. The retracted position 804 is the position that the handle 650 normally is in when the insulated cooler 600 is not being moved. Thus, the handle 650 does not create a hazard to nearby people during these times. While in this retracted position 804, the inner tubular member 842 is substantially inserted into the outer tubular member 832, such that at least a portion of the locking pin 874 protrudes through the second aperture 836 and the inner tubular member 842 is locked with the outer tubular member 832. When a user desires to move the insulated cooler 600 using the wheel assembly 640, the user actuates the actuator 865, by pressing the actuator 865 according to some exemplary embodiments, and telescopically slides the inner tubular member 842 outwardly with respect to the outer tubular member 832, which is positionally fixed with respect to the insulated cooler 600. Thus, the center bar 850 is moved further away from the body 610. When the actuator 865 is depressed, the locking pin 874 moves entirely within the profile of the inner circumference of the outer tubular member 832, thereby unlocking the inner tubular member 842 with respect to the outer tubular member 832. The inner tubular member 842 is then telescopically moved outwardly with respect to the outer tubular member 832. Once the inner tubular member 842 is extended to the extended position 806, the locking pin 874 automatically moves so that at least a portion of the locking pin 874 extends beyond the profile of the inner circumference of the outer tubular member 832. At least a portion of the locking pin 874 extends through the first aperture 834, thereby locking the inner tubular member 842 in the extended position 806 with respect to the outer tubular member 832. In certain exemplary embodiments, the horizontal component of the distance between the center bar 850 and the second latitudinal sidewall 620 is lesser when the handle 650 is positioned in the retracted position 804 than when the handle 650 is positioned in the extended position 806. In certain exemplary embodiments, the length of the handle 650 between the center bar 850 and the second latitudinal sidewall 620 is greater than the vertical height of the second latitudinal sidewall 620 when the handle 650 is positioned in the extended position 806. The user can lift one end of the insulated cooler 600 by lifting the handle 650, i.e. exerting a force on the handle, and then moving the insulated cooler 600 from the first location to a second location. The force the user exerts on the center bar 850 of the handle 650 is less when the handle 650 is extended because the handle 650 functions as a lever and the wheel assembly 640 functions as a fulcrum. The wheel assembly 640 is considered the fixed point at which the insulated cooler 600 rotates once the force is applied onto the handle 650. Thus, in some exemplary embodiments, the center of mass of the insulated cooler 600 is positioned between the wheel assembly 640 and the point at which the force is exerted onto the handle 650. However, the wheel assembly 640 is moved closer to the center of mass of the insulated cooler 600 or even at the position of the center of mass of the insulated cooler 600 according to certain alternative exemplary embodiments. The closer the wheel assembly 640 is to the center of mass of the insulated cooler 600, the less force the user exerts onto the handle 650 to move the insulated cooler 600. Once the insulated cooler 600 has been moved, the process of moving the handle 650 from the retracted position 804 to the extended position 806 is reversed, thereby moving the handle 650 from the extended position 806 to the retracted position 804.

Although exemplary embodiments and certain modifications to those exemplary embodiments have been described with respect to the insulated cooler 100, 500, 600, the described modifications of one exemplary embodiment can be made with respect to another exemplary embodiment. For example, the insulated cooler 100 has been described to include sliding handles 150; however, the telescoping handle 650 of insulated cooler 600 can be used in lieu of handle 150 in certain exemplary embodiments. Also, although some features of the insulated cooler 100, 500, 600 and methods for assembling certain components have been described, other features and/or methods used in known insulated coolers can be applied to the exemplary embodiments described herein and not depart from the scope and spirit of the exemplary embodiments. For example, a liquid spout (not shown) for dispensing liquid can be formed or installed at a lower portion of one of the sides. Also, different wheel assemblies can be used in conjunction with any one of the insulated coolers 100, 500, 600. In another example, the handle 150, 650 does not include the center bar 350, 850.

Although the invention has been described with reference to specific embodiments, these descriptions are not meant to be construed in a limiting sense. Various modifications of the disclosed embodiments, as well as alternative embodiments of the invention will become apparent to persons of ordinary skill in the art upon reference to the description of the exemplary embodiments. It should be appreciated by those of ordinary skill in the art that the conception and the specific embodiments disclosed may be readily utilized as a basis for modifying or designing other structures or methods for carrying out the same purposes of the invention. It should also be realized by those of ordinary skill in the art that such equivalent constructions do not depart from the spirit and scope of the invention as set forth in the appended claims. It is therefore, contemplated that the claims will cover any such modifications or embodiments that fall within the scope of the invention.

What is claimed is:

1. A cooler, comprising:
a body defining a cavity therein, the body comprising:
a base;
a first sidewall and a second sidewall, each of the first and second sidewalls extending from the base and positioned to face one another; and
a third sidewall and a fourth sidewall, each of the third and fourth sidewalls extending from the base, the third sidewall extending from the first sidewall to the second sidewall, the fourth sidewall extending from the first sidewall to the second sidewall, the third sidewall facing the fourth sidewall;
a handle comprising a first bar, a second bar, and a center bar extending from one end of the first bar to one end of the second bar, the first bar being coupled to the first sidewall, the second bar being coupled to the second sidewall, and the handle being extendable from a retracted position to an extended position,
wherein the horizontal component of the distance between the center bar and the fourth sidewall is lesser when the handle is positioned in the retracted position than when the handle is positioned in the extended position.

2. The cooler of claim 1, wherein the handle is slidably coupled to the first and second sidewalls.

3. The cooler of claim 1, wherein the first and second sidewalls each comprise:
a first slot extending from substantially one end of the first and second sidewalls that is adjacent the fourth sidewall towards the opposing end adjacent the third sidewall; and
a protrusion extending outwardly from within the first slot.

4. The cooler of claim 3, wherein the first and second bars are slidably coupled to the respective protrusion and positioned within the respective first slot on each of the first and second sidewalls.

5. The cooler of claim 4, wherein each of the first slots is formed substantially parallel to an upper edge of either the first and second sidewalls.

6. The cooler of claim 4, wherein each of the first slots is formed at an angle ranging from about zero degrees to less than ninety degrees when measured with respect to an upper edge of either the first and second sidewalls.

7. The cooler of claim 3, wherein each of the first and second sidewalls further comprise:
a second slot positioned intersectingly with one end of the first slot that is adjacent the fourth sidewall and angularly with respect to the orientation of the first slot,
wherein the protrusion on each of the first and second sidewalls is positioned at the intersection of the first slot and the second slot.

8. The cooler of claim 7, wherein the first and second bars are slidably and pivotally coupled to the respective protrusion, wherein the first and second bars are positioned within the respective first slot on each of the first and second sidewalls when the handle is in the retracted position, and wherein the first and second bars are positioned within the respective second slot on each of the first and second sidewalls when the handle is in an extended and tilted position.

9. The cooler of claim 1, wherein the handle is telescopically coupled to the first and second sidewalls.

10. The cooler of claim 9, wherein the first and second sidewalls each comprise a slot extending from substantially one end of the first and second sidewalls that is adjacent the fourth sidewall towards the opposing end adjacent the third sidewall.

11. The cooler of claim 10, wherein the first and second bars each comprise:
an outer tubular member comprising a channel extending therein; and
an inner tubular member inserted within the channel and telescopically coupled to the outer tubular member,
wherein the center bar is coupled to one end of the inner tubular member of each of the first and second bars, and
wherein the outer tubular member is fixedly coupled to the first and second sidewalls within the slot on each of the first and second sidewalls.

12. The cooler of claim 11, wherein each of the slots is formed substantially parallel to an upper edge of either the first and second sidewalls.

13. The cooler of claim 11, wherein each of the first and second sidebars comprise an actuator, the actuator being capable of unlocking the inner tubular member from the outer tubular member when the handle is in retracted position.

14. The cooler of claim 11, wherein each of the first and second sidebars comprise an actuator, the actuator being capable of unlocking the inner tubular member from the outer tubular member when the handle is in extended position.

15. A method for assembling an insulated cooler, comprising:
providing a body defining a cavity therein, the body comprising:
a base;
a first sidewall and a second sidewall, each of the first and second sidewalls extending from the base and positioned to face one another; and
a third sidewall and a fourth sidewall, each of the third and fourth sidewalls extending from the base, the third sidewall extending from the first sidewall to the second sidewall, the fourth sidewall extending from the first sidewall to the second sidewall, the third sidewall facing the fourth sidewall;
coupling a handle to the first and second sidewalls, the handle comprising a first bar, a second bar, and a center bar extending from one end of the first bar to one end of the second bar, the first bar being coupled to the first sidewall, the second bar being coupled to the second sidewall, and the handle being extendable from a retracted position to an extended position; and
coupling at least one wheel assembly to the base;
wherein the horizontal component of the distance between the center bar and the fourth sidewall is lesser when the handle is positioned in the retracted position than when the handle is positioned in the extended position.

16. The method of claim 15, wherein the handle is slidably coupled to the first and second sidewalls.

17. The method of claim 15, wherein the first and second sidewalls each comprise:
a first slot extending from substantially one end of the first and second sidewalls that is adjacent the fourth sidewall towards the opposing end adjacent the third sidewall; and
a protrusion extending outwardly from within the first slot, and
wherein the first and second bars are slidably coupled to the respective protrusion and positioned within the respective first slot on each of the first and second sidewalls.

18. The method of claim 17, wherein each of the first and second sidewalls further comprise a second slot positioned intersectingly with one end of the first slot that is adjacent the fourth sidewall and angularly with respect to the orientation of the first slot, wherein the protrusion on each of the first and second sidewalls is positioned at the intersection of the first slot and the second slot, wherein the first and second bars are slidably and pivotally coupled to the respective protrusion, wherein the first and second bars are positioned within the respective first slot on each of the first and second sidewalls when the handle is in the retracted position, and wherein the first and second bars are positioned within the respective second slot on each of the first and second sidewalls when the handle is in an extended and tilted position.

19. The method of claim 15, wherein the handle is telescopically coupled to the first and second sidewalls.

20. The method of claim 19, wherein the first and second bars each comprise:
an outer tubular member comprising a channel extending therein; and
an inner tubular member inserted within the channel and telescopically coupled to the outer tubular member,
wherein the center bar is coupled to one end of the inner tubular member of each of the first and second bars, and
wherein the outer tubular member is fixedly coupled to the first and second sidewalls.

21. The method of claim 19, wherein each of the first and second sidebars comprise an actuator, the actuator being capable of unlocking the inner tubular member from the outer tubular member when the handle is in at least one of the retracted position and the extended position.

22. A cooler, comprising:
a body comprising:
a base;
a first sidewall and a second sidewall, each of the first and second sidewalls extending from the base and positioned to face one another; and
a third sidewall and a fourth sidewall, each of the third and fourth sidewalls extending from the base, the third sidewall extending from the first sidewall to the second sidewall, the fourth sidewall extending from the first sidewall to the second sidewall, the third sidewall facing the fourth sidewall;
a handle comprising a first bar, a second bar, and a center bar extending from one end of the first bar to one end of the second bar, the first bar being coupled to the first sidewall, the second bar being coupled to the second sidewall, and the handle being extendable from a retracted position to an extended position; and
at least one wheel assembly coupled to the lower portion of the base adjacent the third sidewall,
wherein the length of the handle between the center bar and the fourth sidewall is greater than the vertical height of the fourth sidewall when the handle is positioned in the extended position.

23. The cooler of claim 22, wherein the handle is slidably coupled to the first and second sidewalls.

24. The cooler of claim 22, wherein the handle is telescopically coupled to the first and second sidewalls.
